(19) United States
(12) Patent Application Publication
(10) Pub. No.: US 2004/0193832 A1
(43) Pub. Date: Sep. 30, 2004

(54) Physical mode windows

(76) Inventors: David J. Garcia, Los Gatos, CA (US); Kathryn Hampton, Los Gatos, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/401,230

(22) Filed: Mar. 27, 2003

(51) Int. Cl. G06F 12/10

(52) U.S. Cl. 711/202; 711/220; 711/203

(57) ABSTRACT

The disclosed embodiments may relate to an address translation mechanism that includes a request that corresponds to a memory access operation, the request having an offset field that stores an offset. Also included may be an address mode field that contains a value that indicates whether physical mode addressing is available for the request. The address translation mechanism may also include a memory window context that relates the offset to a physical address if the address mode field indicates that physical mode addressing is available for the request.

### BACKGROUND OF THE RELATED ART

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

In the field of computer systems, it may be desirable for information to be transferred from a system memory associated with one computer system to a system memory associated with another computer system. Queue pairs (“QPs”) may be used to facilitate such a transfer of data. Each QP may include a send queue (“SQ”) and a receive queue (“RQ”) that may be utilized in transferring data from the memory of one device to the memory of another device. The QP may be defined to expose a segment of the memory within the local system to a remote system. Memory windows may be used to ensure that memory exposed to remote systems may be accessed by designated QPs. The information about the memory windows and memory regions may be maintained within a memory translation and protection table (“TPT”). Steering tags (“Stags’) may be used to direct access to a specific entry within the TPT. In addition to the TPT, a physical address table (“PAT”) may be implemented to convert the fields of the in the TPT to physical addresses of memory.

However, before the memory segments may be accessed, either locally or remotely, the memory segments may first be registered. A process or application may register memory to allow access to that memory segment or memory region from the local system or a remote system. Upon completion of the operation, the memory region may be deregistered to prevent subsequent access by an unauthorized QP. The registration/deregistration process is time consuming and expensive in terms of computing resources. Extensive registration operations may also inhibit system performance by creating excessive entries in TPTs and/or the hardware memory translation logic.

### BRIEF DESCRIPTION OF THE DRAWINGS

Advantages of the invention may become apparent upon reading the following detailed description and upon reference to the drawings in which:

FIG. 1 is a block diagram illustrating a computer network in accordance with embodiments of the present invention;

FIG. 2 is a block diagram illustrating a simplified exchange between computers in a computer network in accordance with embodiments of the present invention;

FIG. 3 is a block diagram showing the processing of a memory request and associated TPT information in accordance with embodiments of the present invention;

FIG. 4 is a process flow diagram in accordance with embodiments of the present invention;

FIG. 5 is a process flow diagram that illustrates allocation of an STag in accordance with embodiments of the present invention;

FIG. 6 is a process flow diagram of a bind operation in accordance with embodiments of the present invention; and

FIG. 7 is a process flow diagram showing the translation of an incoming request in accordance with embodiments of the present invention.

### DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The Remote Direct Memory Access (“RDMA”) Consortium, which includes the assignee of the present invention, is developing specifications to improve ability of computer systems to remotely access the memory of other computer systems. One such specification under development is the RDMA Consortium Protocols Verb specification, which is hereby incorporated by reference. The verbs defined by this specification may correspond to commands or actions that may form a command interface for data transfers between memories in computer systems, including the formation and management of queue pairs, memory windows, protection domains and the like.

RDMA may refer to the ability of one computer to directly place information in the memory space of another computer, while minimizing demands on the central processing unit (“CPU”) and memory bus. In an RDMA system, an RDMA layer may interoperate over any physical layer in a Local Area Network (“LAN”), Server Area Network (“SAN”), Metropolitan Area Network (“MAN”), or Wide Area Network (“WAN”).

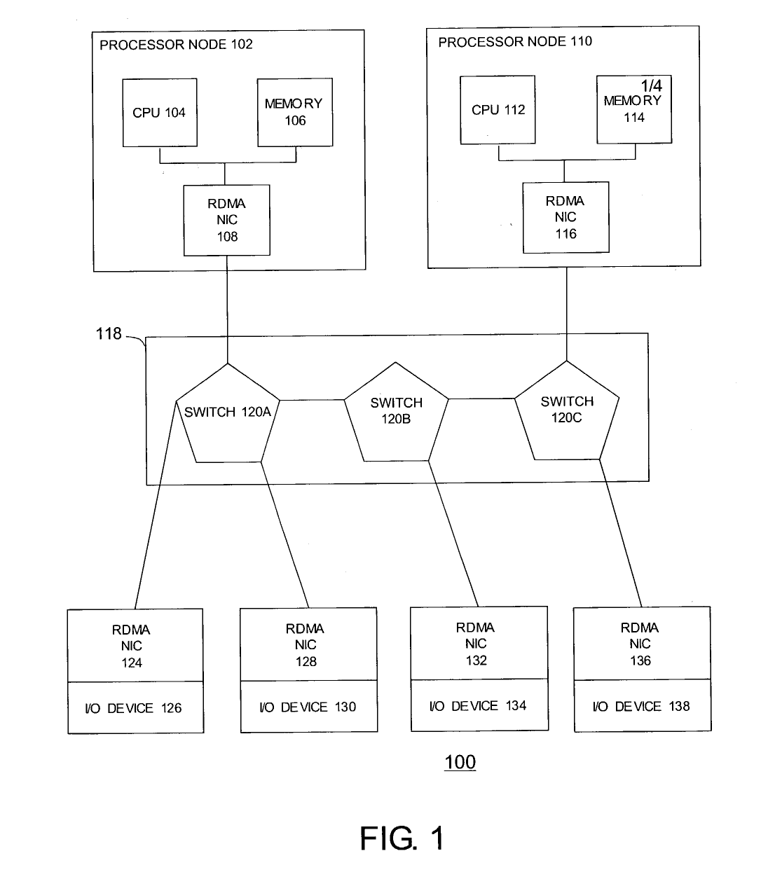

Referring now to FIG. 1, a block diagram illustrating a computer network in accordance with embodiments of the present invention is illustrated. The computer network is indicated by the reference numeral 100 and may comprise a first processor node 102 and a second processor node 110, which may be connected to a plurality of I/O devices 126, 130, 134, and 138 via a switch network 118. Each of the I/O devices 126, 130, 134 and 138 may utilize a Remote Direct Memory Access-enabled Network Interface Card (“RNIC”) to communicate with the other systems. In FIG. 1, the RNICs associated with ihe I/O devices 126, 130, 134 and 138 are identified by the reference numerals 124, 128, 132 and 136, respectively. The I/O devices 126, 130, 134, and 138 may access the memory space of other RDMA-enabled devices via their respective RNICs and the switch network 118.

The topology of the network 100 is for purposes of illustration only. Those of ordinary skill in the art will appreciate that the topology of the network 100 may take on a variety of forms based on a wide range of design considerations. Additionally, NICs that operate according to other protocols, such as InfiniBand, may be employed in networks that employ such protocols for data transfer.

The first processor node 102 may include a CPU 104, a memory 106, and an RNIC 108. Although only one CPU 104 is illustrated in the processor node 102, those of ordinary skill in the art will appreciate that multiple CPUs may be included therein. The CPU 104 may be connected to the memory 106 and the RNIC 108 over an internal bus or connection. The memory 106 may be utilized to store information for use by the CPU 104, the RNIC 108 or other systems or devices. The memory 106 may include various types of memory such as Static Random Access Memory (“SRAM”) or Dynamic Random Access Memory (“DRAM”).

The second processor node 110 may include a CPU 112, a memory 114, and an RNIC 116. Although only one CPU 112 is illustrated in the processor node 110, those of ordinary skill in the art will appreciate that multiple CPUs may be included theein. The CPU 112, which may include a plurality of processors, may be connected to the memory 114 and the RNIC 116 over an internal bus, or connection. The memory 114 may be utilized to store information for use by the CPU 112, the RNIC 116 or other systcms or devices. The memory 114 may utilize various types of memory such as SRAM or DRAM.

The switch network 118 may include any combination of hubs, switches, routers and the like. In FIG. 1, the switch network 118 comprises switches 120A-120C. The switch 120A connects to the switch 120B, the RNIC 108 of the first processor node 102, the RNIC 124 of the I/O device 126 and the RNIC 128 of the I/O device 130. In addition to its connection to the switch 120A, the switch 120B connects to the switch 120C and the RNIC 132 of the I/O device 134. In addition to its connection to the switch 120B, the switch 120C connects to the RNIC 116 of the second processor node 110 and the RNIC 136 of the I/O device 138.

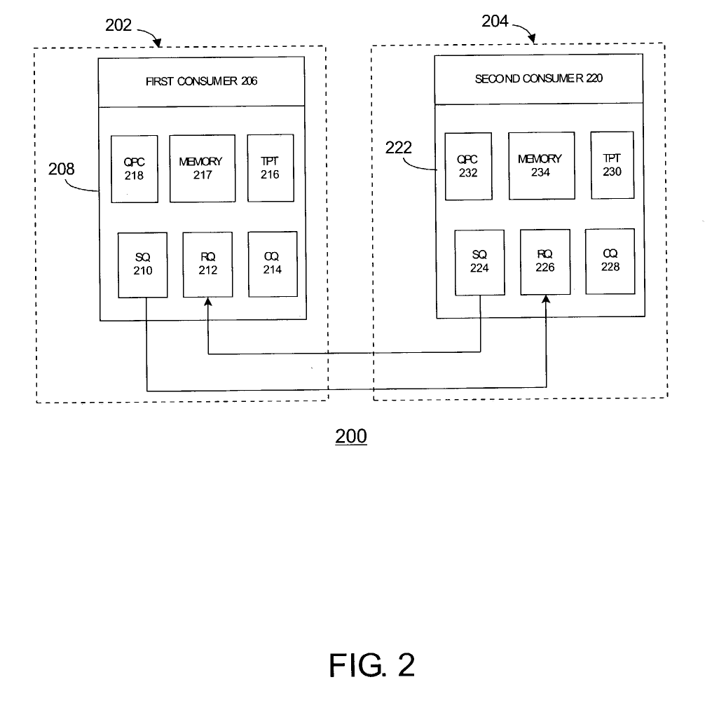

Each of the processor nodes 102 and 110 and the I/O devices 126, 130, 134, and 138 may be given equal priority and the same access to the memory 106 or 114. In addition, the memories may be accessible by remote devices such as the I/O devices 126, 130, 134 and 138 via the switch network 118. The first processor node 102, the second processor node 110 and the I/O devices 126, 130, 134 and 138 may exchange information using queue pairs (“QPs”). The exchange of information using QPs is explained with reference to FIG. 2.

FIG. 2 is a block diagram that illustrates the use of a queue pair to transfer data between devices in accordance with embodiments of the present invention. The figure is generally referred to by the reference numeral 200. In FIG. 2, a first node 202 and a second node 204 may exchange information using a QP. The first node 202 and second node 204 may correspond to any two of the first processor node 102, the second processor node 110 or the I/O devices 126, 130, 134 and 138 (FIG. 1). As set forth above with respect to FIG. 1, any of these devices may exchange information in an RDMA enviroument.

The first node 202 may include a first consumer 206, which may interact with an RNIC 208. The first consumer 206 may comprise a software process that may interact with various components of the RNIC 208. The RNIC 208, may correspond to one of the RNICs 108, 116, 126, 130, 134 or 138 (FIG. 1), depending on which of devices associated with those RNICs is participating in the data transfer. The RNIC 208 may comprise a send queue 210, a receive queue 212, a completion queue (“CQ”) 214, a memory translation and protection table (“TPT”) 216, a memory 217 and a QP context 218.

The second node 204 may include a second consumer 220, which may interact with an RNIC 222. The second consumer 220 may comprise a software process that may interact with various components of the RNIC 222. The RNIC 222, may correspond to one of the RNICs 108, 116, 126, 130, 134 or 138 (FIG. 1), depending on which of devices associated with those RNICs is participating in the data transfer. The RNIC 222 may comprise a send queue 224, a receive queue 226, a completion queue 228, a TPT 230, a memory 234 and a QP context 232.

The memories 217 and 234 may be registered to different processes, each of which may correspond to the consumers 206 and 220. The queues 210, 212, 214, 224, 226, or 228 may be used to transmit and receive various verbs or commands, such as control operations or transfer operations. The completion queue 214 or 228 may store information regarding the sending status of items on the send queue 210 or 224 and receiving status of items on the receive queue 212 or 226. The TPT 216 or 230 may comprise a simple table or an array of page specifiers that may include a variety of configuration information in relation to the memories 217 or 234.

The QP associated with the RNIC 208 may comprise the send queue 210 and the receive queue 212. The QP associated with the RNIC 222 may comprise the send queue 224 and the receive queue 226. The arrows between the send queue 210 and the receive queue 226 and between the send queue 224 and the receive queue 212 indicate the flow of data or information therebetween. Before communication between the RNICs 208 and 222 (and their associated QPs) may occur, the QPs may be established and configured by an exchange of commands or verbs between the RNIC 208 and the RNIC 222. The creation of the QP may be initiated by the first consumer 206 or the second consumer 220, depending on which consumer desires to transfer data to or retrieve data from the other consumer.

Information relating to the configuration of the QPs may be stored in the QP context 218 of the RNIC 208 and the QP context 232 of the RNIC 222. For instance, the QP context 218 or 232 may include information relating to a protection domain (“PD”), access rights, send queue information, receive queue information, completion queue information, or information about a local port connected to the QP and/or remote port connected ID the QP. However, it should be appreciated that the RNIC 208 or 222 may include multiple QPs that support different consumers with the QPs being associated with one of a number of CQs.

To prevent interferences in the memories 217 or 234, the memories 217 or 234 may be divided into memory regions (“MRs”), which may contain memory windows (“MWs”). An entry in the TPT 216 or 230 may describe the memory regions and may include a virtual to physical mapping of a portion of the address space allocated to a process. A physical address table (“PAT”) may also be used to perform memory mapping. Memory regions may be registered with the associated RNIC and the operating system (“OS”). The nodes 202 and 204 may send a unique steering field or steering tag (“STag”) to identify the memory to be accessed, which may correspond to the memory region or memory window. Access to a memory region by a designated QP may be restricted to STags that have the same protection domain.

The STag may be used to identify a buffer that is being referenced for a given data transfer. A tagged offset (“TO”) may be associated with the STag and may correspond to an offset into the associated buffer. Alternatively, a transfer may be identified by a queue number, a message sequence number and message offset. The queue number may be a 32-bit field, which identifies the queue being referenced. The message sequence number may be a 32-bit field that may be used as a sequence number for a communication, while the message offsetmay be a 32-bit field offset from the start of the message.

To obtain access to one of the memories 217 and 234, the consumer 206 or 220 may issue a command that may include a work request (“WR”), which may result in the creation of a work queue element (“WQE”) that may be posted to the appropriate queue. The request may include an STag, a tagged offset, a length and the like. Access rights may be verified and a connection path may be established between the RNICs 208 and 222 by mapping a QP at each node 202 and 204 together. For example, in FIG. 2, the send queue 212 and the receive queue 214 of the first node 202 may form a QP that may interact with the QP of the send queue 224 and the receive queue 226 of the second node 204. The node that has been requested to send data may send the data to the requesting node. The requesting node may then retire the work request. For instance, a completion may be generated to the completion queue 214 when a consumer requests it for an outbound RDMA read and write or when an incoming send is posted to the receive queue.

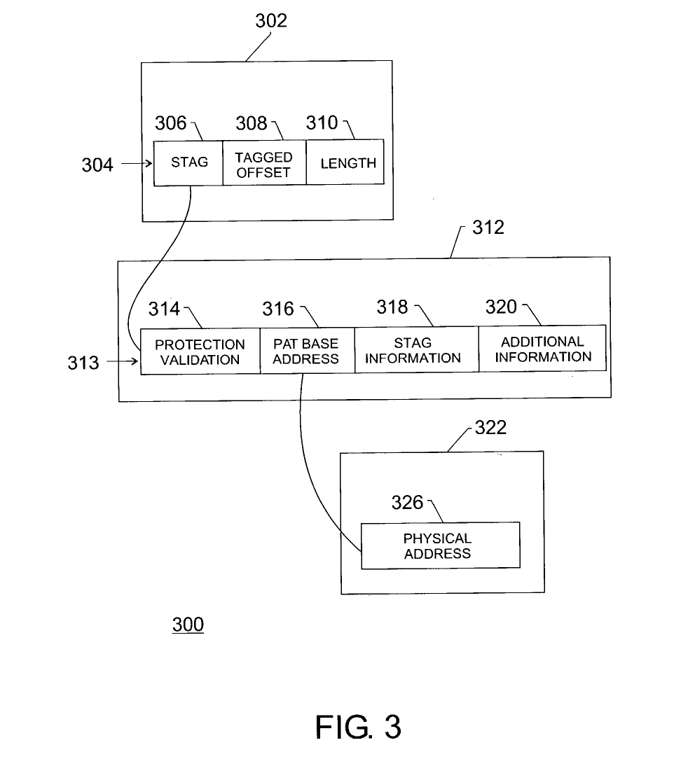

After completion of an operation, memory regions and memory windows used in that operation may be deregistered. The process of registering and deregistering memory regions and memory windows may be time consuming and resource intensive. However, the overhead associated with registering and deregistering memory regions is greater than the overhead associated with registering and deregistering memory windows. The reduction of the overhead associated with registering and deregistering memory regions and memory windows is explained with respect to FIG. 3.

FIG. 3 is a block diagram showing the processing of a memory request and associated TPT information in accordance with embodiments of the present invention. The diagram, which is generally referred to by the reference numeral 300, may relate to address translation including physical or virtual addressing. A request 302 may correspond to a memory access operation, such as a work request or an incoming RDMA read or write request. A work request may include a scatter/gather list (“SGL”) element 304. The SGL element 304 may include information, such as a steering field or steering tag (“STag”) 306, a tagged offset 308, and a length 310, which may comprise a base and bounds. The STag 306 may correspond to an entry in a TPT 312, which may correspond to the TPT 216 or the TPT 230 of FIG. 2. The STag 306 may function as an address mode field, which may be used to select between virtual and physical addressing. The STag 306 may function to select a corresponding TPT entry (“TPTE”) 313 in the TPT 312. The TPT entry 313 may include steering information related to a specific memory location, such as a location in the memories 217 or 234 (FIG. 2). The tagged offset field 308 may identify the offset in a corresponding buffer.

The information contained in the TPT entry 313 may describe a memory region or memory window. The TPT configuration information for a memory window, which may be referred to as a memory window context, may indicate whether a memory window associated with request 302 has been bound to physical memory. The TPTE 313 may comprise a protection validation field 314, a physical address table base address 316, an STag information field 318 and an additional information field 320, which may comprise access controls, key instance data, protection domain data, window reference count, physical address table size, page size, first page offset, base or bounds, or length, for example.

The protection validation field 314, which may correspond to a protection domain number, may validate whether a requested memory access is authorized. The protection of memory may be maintained because the protection validation field 314 may be associated with the QP that is participating in a data transfer to validate that the physical addressing is authorized and valid. In addition, separate validation bits may be utilized to enable local and remote physical addressing.

If a request does not require physical mode addressing, it may be processed using a memory translation process that requires access to a physical address table 322. The physical address table base address 316 of the TPTE 313 may correspond to the base address of a physical address table 322. The physical address table 322 may include the virtual to physical translation for each page in a memory region, including a physical address 326. The physical address table base address 316 may be combined with a portion of the TO 308 to index the physical address table 322, which may return the corresponding physical address 326. The combination of the physical address table base address 316 and the tagged offset 308 may be an arithmetic combination that may be adjusted depending upon the memory region or memory window addressing mode. If the STag information 318 indicates that an associated memory request is directed to a physical mode window, such as a memory window that has been bound to physical memory, the address translation process may be shortened or simplified.

In a memory access operation, the STag 306 may access a physical address through a memory window if the STag 306 points to a TPT entry 313 that corresponds to a physical window. For example, the TPT entry 313 may correspond to a physical window if certain predetermined values are present in specific fields or locations of the TPT entry 313. In such a case, the physical window may correspond to a physical address. If physical window addressing is indicated, the tagged offset 308 of the SGL element 304 may have a physical memory address embedded therein. Alternatively, the special value or indication corresponding to physical window addressing may be contained in a QP context, such as the QP context 218 or 232 of FIG. 2. Once the request is validated, the request may directly access the memory location using the physical embedded in the TO 308 without further address translation processing. The use of physical window addressing may allow a request and/or associated work queue element to access physical memory through a memory window without creating or accessing an entry in the physical address table 322. Additionally, physical window addressing may allow access to physical memory without the performance of high-overhead operations such as execution of a Register Memory Region verb or operation.

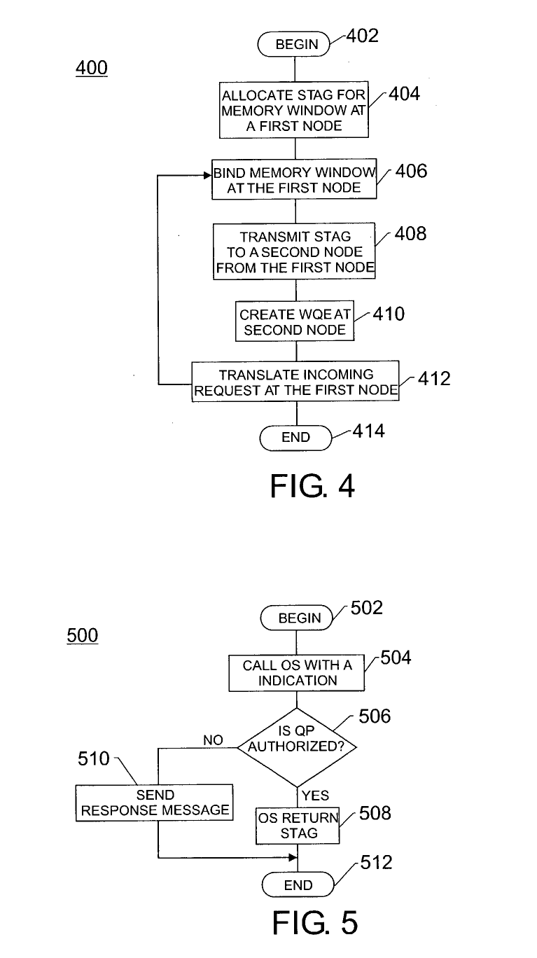

FIG. 4 is a process flow diagram in accordance with embodiments of the present invention. In the diagram, generally referred to by reference numeral 400, a physical mode window may be implemented and may be utilized in a system, such as a computer system. The process begins at block 402. At block 404, an STag may be allocated for a window at a first or requesting node, such as the nodes 202 or 204 of FIG. 2. The allocation of the STag may involve a call to the OS with the OS returning the appropriate STag that corresponds to a memory location or TPT entry, such as the TPT entry 313 in the TPT 312 of FIG. 3. The allocation of the STag for a memory window may be done once, while the memory window may be repeatedly bound. The memory window may be bound with a Bind Memory Window verb, command or operation, as shown at block 406. The binding of the memory window may involve filling in the entry in the TPT that was created at block 404. The STag may then be communicated to a second node in block 408.

At block 410, a second or target node of the memory access operation may create a work queue element or WQE to be able to access the memory window created at block 406. The WQE may result in the generation of an RDMA read or write request. The RDMA request may be transmitted to the first node from the second node. At block 412, the first node may translate the incoming request. The request may be translated by accessing the TPT with the STag to access the memory window into the physical address space. To allow the access, an address mode field such as the STag field 306 (FIG. 3) may be verified within the TPT entry or within the queue pair context. Once the request is translated, the access may be either allowed or denied. If the second node subsequently notifies the first node that it has completed accesses to the memory window, the first node may reuse the TPT entry and bind it to a new window. However, the first node may or may not repeat the allocate step.

FIG. 5 is a process flow diagram that illustrates allocation of a STag in accordance with embodiments of the present invention. The allocation of an STag shown in FIG. 5 may correspond to the STag allocation shown in block 404 of FIG. 4. In the diagram, generally referred to by reference numeral 500, a physical mode window may be allocated and may be utilized in a system, which may correspond to block 404 of FIG. 4. The process begins at block 502. At block 504, a call to an OS may be placed. The call may include a special indication that the memory window may provide access into physical memory. At block 506, the OS may verify that the requesting QP is authorized to access the memory windows to physical memory. If the QP is authorized, then the OS may respond with an STag for use in the operation at block 508. However, if the QP is not authorized, then the OS may respond with a message that indicates that the call failed at block 510. Accordingly, the process ends at block 512.

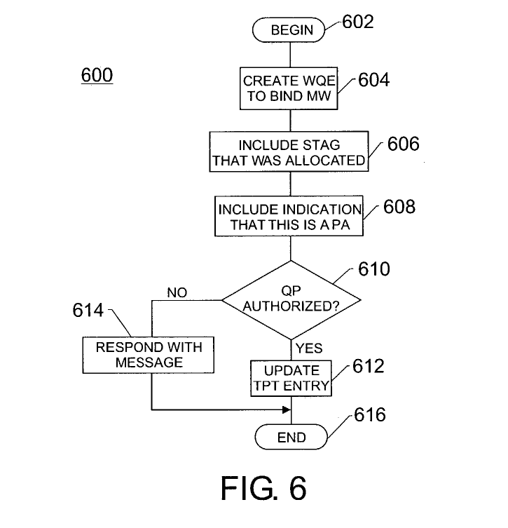

FIG. 6 is a process flow diagram of a bind operation in accordance with embodiments of the present invention. The bind operation shown in FIG. 6 may correspond to the bind operation shown in block 406 of FIG. 4. In the diagram, generally referred to by reference numeral 600, a physical mode window may be created, which may correspond to block 406 of FIG. 4. The process begins at block 602. At block 604, a work queue element or WQE may be generated to bind the memory window. The WQE may include an STag at block 606. The STag may be the STag formed in the flow chart 500 of FIG. 5, which corresponds to a specific TPT entry. At block 608, the indicator or address mode field may be included in the WQE for insertion into the TPT entry or queue pair context. The special indicator may indicate that the memory window corresponds to a physical address. Then, at block 610, the work request may be processed by the send queue and the QP may be verified to determine if the QP is authorized to access physical memory windows. If the QP is authorized, then the TPT entry may be updated with the STag and other information at block 612. However, if the QP is not authorized, then a respond message may indicate that the Bind operation has failed at block 614. Accordingly, the process ends at block 616.

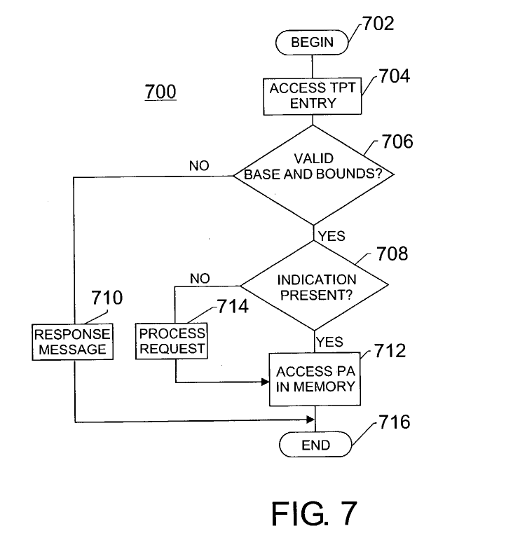

FIG. 7 is a process flow diagram showing the translation of an incoming request in accordance with embodiments of the present invention. In the diagram, generally referred to by reference numeral 700, an incoming request may be received and may be utilized to access a memory window that allows access to physical memory, which may correspond to block 412 of FIG. 4. The process begins at block 702. At block 704, an STag may be utilized to access a TPT, such as TPT 312 of FIG. 3. The STag may correspond to a specific entry within the TPT. At block 706, the base and bounds of the access may be verified. If the base and bounds are valid, then the special indication or special value may be verified in block 708. However, if the base and bounds are invalid, then a response message may be transmitted to the requesting node indicating that the request failed at block 710.

At block 708, the special indicator or address mode field may be verified to determine if the access is for a memory window that relates to a physical address or is a normal memory window request. The special indicator may be located within the TPT entry for the memory window or within the queue pair context. If the special indicator is present, then the queue pair may be verified that it is authorized for access and/or access may be provided to the request at block 712. However, if the special indicator is not present, then the request may be processed as a normal request at block 714. The normal processing of the request may include accessing an entry in the PAT and then proceeding with processing at block 712. Accordingly, the process ends at block 716.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. An address translation mechanism, comprising:
a request that corresponds to a memory access operation, the request having an offset field that stores an offset;
an address mode field that contains a value that indicates whether physical mode addressing is available for the request; and
a memory window context that relates the offset to a physical address if the address mode field indicates that physical mode addressing is available for the request.

2. The address translation mechanism set forth in claim 1, wherein the request comprises a steering tag (“STag”) that identifies the memory window context.

3. The address translation mechanism set forth in claim 1, wherein the address mode field is part of a memory window context.

4. The address translation mechanism set forth in claim 1, wherein the request is an incoming remote direct memory access (“RDMA”) request.

5. The address translation mechanism set forth in claim 1, wherein the address mode field indicates that physical mode addressing is available for the request if the address mode window contains a predetermined value.

6. The address translation mechanism set forth in claim 1, wherein a queue pair context corresponds to the memory window context and verifies whether the physical mode addressing is available for the request.

7. The address translation mechanism set forth in claim 1, wherein the address field corresponds to a virtual address if the address mode field does not indicate that physical mode addressing is available for the request.

8. A computer network, comprising:
a plurality of computer systems;
at least one input/output device;
a switch network that connects the plurality of computer systems and the at least one input/output device for communication; and
wherein the plurality of computer systems and the at least one input/output device comprises an address translation mechanism, comprising:
a request that corresponds to a memory access operation, the request having an offset field that stores an offset;
an address mode field that contains a value that indicates whether physical mode addressing is available for the request; and
a memory window context that relates the offset to a physical address if the address mode field indicates that physical mode addressing is available for the request.

9. The computer network set forth in claim 8, wherein the request comprises a steering tag (“STag”) that identifies the memory window context.

10. The computer network set forth in claim 8, wherein the address mode field is part of a memory window context.

11. The computer network set forth in claim 8, wherein the request is an incoming remote direct memory access (“RDMA”) request.

12. The computer network set forth in claim 8, wherein the address mode field indicates that physical mode addressing is available for the request if the address mode window contains a predetermined value.

13. The computer network set forth in claim 8, wherein a queue pair context corresponds to the memory window context and verifies whether the physical mode addressing is available for the request.

14. The computer network set forth in claim 8, wherein the address field corresponds to a virtual address if the address mode field does not indicate that physical mode addressing is available for the request.

15. A method of accessing memory locations in a computer system, the method comprising:
allocating an address mode field and a steering field for a memory window context, the
memory window context including an address field;
binding a memory window context to the steering field;
translating the request to determine the memory window context, the request comprising
an steering field and an offset field;
accessing a physical address using the offset field if the address mode field indicates that physical mode addressing is available;
accessing a virtual address using the address field if the address mode field does not indicate that physical mode addressing is available.

16. The method set forth in claim 15, wherein the address mode field is part of a memory window context.

17. The method set forth in claim 15, wherein the request is an incoming remote direct memory access (“RDMA”) request.

18. The method set forth in claim 17, wherein allocating further comprises verifying a queue pair field.

19. The method set forth in claim 15, wherein binding further comprises allocating a range of physical addresses for the memory window context.

20. The method set forth in claim 15, further comprising defining the address mode field and the address field as part of a translation and protection table (“TPT”).

21. The method set forth in claim 20, wherein translating further comprises using the steering tag to access an entry in the TPT.

22. The method set forth in claim 15, wherein allocating further comprises validating that the queue pair is authorized to access physical memory.
